(19) United States
(12) Patent Application Publication
(10) Pub. No.: US 2006/0012585 A1
(43) Pub. Date: Jan. 19, 2006

(54) Multi output dc/dc converter for liquid crystal display device

(76) Inventors: Franciscus Schoofs, Eindhoven (NL); Wilhelmus Van Lier, Heerlen (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/535,752

(22) PCT Filed: Nov. 21, 2003
(86) PCT No.: PCT/IB03/05316

§ 371 Date: May 19, 2005

(30) Foreign Application Priority Data
Nov. 25, 2002 (EP) 02079886.4

(51) Int. Cl. G09G 5/00

(52) U.S. Cl. 345/204

(57) ABSTRACT

A liquid crystal display (LCD) system comprising means for generating a number of LCD drive voltages with values symmetrical with respect to a predetermined voltage value, said means having a configuration of buffer capacitors to provide each of the LCD drive voltages with a buffer capacitance, the LCD system further comprising an LCD driver circuit with matrix switching and control means to supply the terminals of an LCD panel with voltages corresponding to said LCD drive voltages, resulting in a proper light level of the pixels of the LCD panel. To define the LCD drive voltage values, at least one charge pump unit is provided with at least one pump capacitor and switching elements, which at least one charge pump unit is connected to the buffer capacitors.

The invention relates to a liquid crystal display (LCD) system, comprising means for generating a number of LCD drive voltages with values symmetrical with respect to a predetermined voltage value, said means having a configuration of buffer capacitors to provide each of the LCD drive voltages with a buffer capacitance, the LCD system further comprising an LCD driver circuit with matrix switching and control means to supply the terminals of an LCD panel with voltages corresponding to said LCD drive voltages, resulting in a proper light level of the pixels of the LCD panel.

In practice LCD modules are required which are fed only by a given voltage source, particularly a battery, or with a voltage derived from a battery and have a given format for the pictures on the panel. One of the most important applications for small LCD systems is in cellular phones; the voltage supply source in such applications is a battery. Mostly this battery is a single Li-ion cell or is formed by Ni-type cells, such as nickel-cadmium (NiCd) or nickel-metal hydride (Ni) cells. In practice, the battery voltage ranges from 4.2 to 2.5 V with Li-type batteries and from 4.8 to 0.9 V with Ni-type batteries when fully charged and gradually becoming fully discharged. The required LCD drive voltages is to be generated from this single battery supply voltage. The standby power consumption is, besides picture quality, one of the most important parameters for cellular phones. The display is on all the time, and thus power supply of the display is a matter of concern. Therefore, the conversion of a single battery voltage into a number of well-controlled LCD drive voltages needs to be done with relatively high efficiency in order to keep the standby power consumption low.

An LCD system as described in the opening paragraph is known from U.S. Pat. No. 5,986,649. A charge pump technique is applied in the means for generating a number of symmetrical LCD voltages in said document to obtain well defined voltages V3 and −V3, whereas well-defined intermediate voltages V2, VC and −V2 are generated by means of driver elements including resistors R1-R4, operational amplifiers OP1 and OP2, and a serial configuration of capacitors C1-C4. Although this known system generates well-defined LCD drive voltage, the application of such driver elements in combination with load currents occurring in these amplifiers results in a dissipation of energy, particularly in the operational amplifiers, which will not always be acceptable in practice.

The purpose of the invention is to provide an LCD system wherein the dissipation in the means for generating the LCD drive voltages is strongly reduced in comparison with the known configuration.

Therefore, according to the invention, the LCD system as described in the opening paragraph is characterized in that at least one charge pump unit with at least one pump capacitor and switching elements is connected to the buffer capacitors.

The combination of buffer capacitors together with the application of charge pump technology at the output of the buffer capacitors renders the exchange of charge between the several buffer capacitors with high efficiency possible. The use of buffer amplifiers, as in the case of the above prior art, is superfluous now, so that less power will be dissipated in the LCD system.

The buffer capacitor configuration can be realized in different ways. The above prior art document teaches a serial configuration of buffer capacitors arranged between the output terminals of a single supply voltage device with a buffer capacitor between each of the LCD drive voltages. A further possible buffer capacitor configuration is a star configuration, where the buffer capacitors are arranged between the respective LCD drive voltages and a common point, for example ground or the LCD drive voltage with respect to which the other LCD drive voltages have symmetrical values. Combinations of a serial configuration and a star configuration of buffer capacitors are also possible.

In a more particular embodiment, the LCD system is characterized in that the means for generating a number of LCD drive voltages comprises a DC/DC converter to supply an output voltage for the configuration of buffer capacitors, and that a charge pump unit is provided comprising at least one first pump capacitor and respective switches to define a first group of LCD drive voltage differences and at least one second pump capacitor and respective switches to define, in combination with the at least one first pump capacitor and respective switches, a second group of LCD drive voltage differences, the latter voltage differences being substantially equal to the LCD drive voltage differences of the first group. In another particular embodiment, the LCD system is characterized in that the means for generating a number of LCD drive voltages comprises a DC/DC converter to supply an output voltage for the configuration of buffer capacitors, and that a first charge pump unit is provided comprising at least one pump capacitor and respective switches to define a first group of LCD drive voltage differences, and a second charge pump unit comprising at least one pump capacitor and respective switches to define a second group of LCD drive voltage differences. Combinations of the two embodiments are possible.

An LCD system will be provided particularly for cellular phones, in which the means for generating a number of LCD drive voltages comprises a DC/DC up-converter fed by a battery voltage to generate the LCD drive voltages. Nevertheless, a DC/DC down-converter fed by a battery voltage to generate the LCD drive voltages may alternatively be applied. This may have advantages because down-conversion provides less output ripple than up-conversion. The applicable lower capacitance values can lead to smaller dimensions and a lower cost price. Of course, the choice of up-conversion or down-conversion will have consequences for the realization of control circuits of the charge pump unit.

The invention will be apparent from and elucidated with reference to the examples as described in the following and to the accompanying drawing. In this drawing

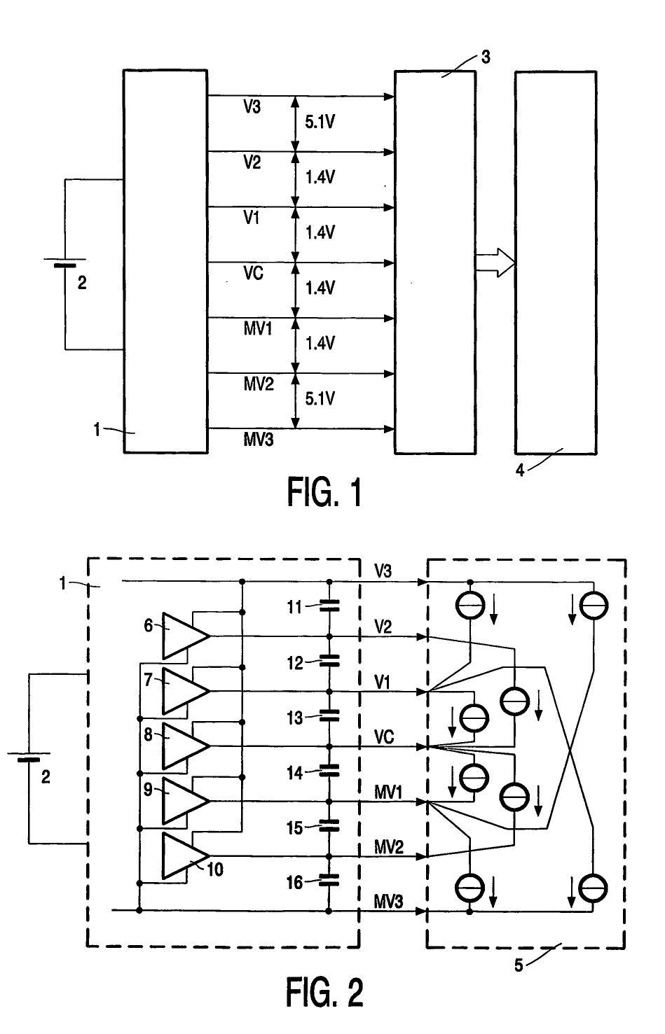

FIG. 1 is a basic diagram of an LCD system;

FIG. 2 shows an LCD system with driver elements according to the state of the art;

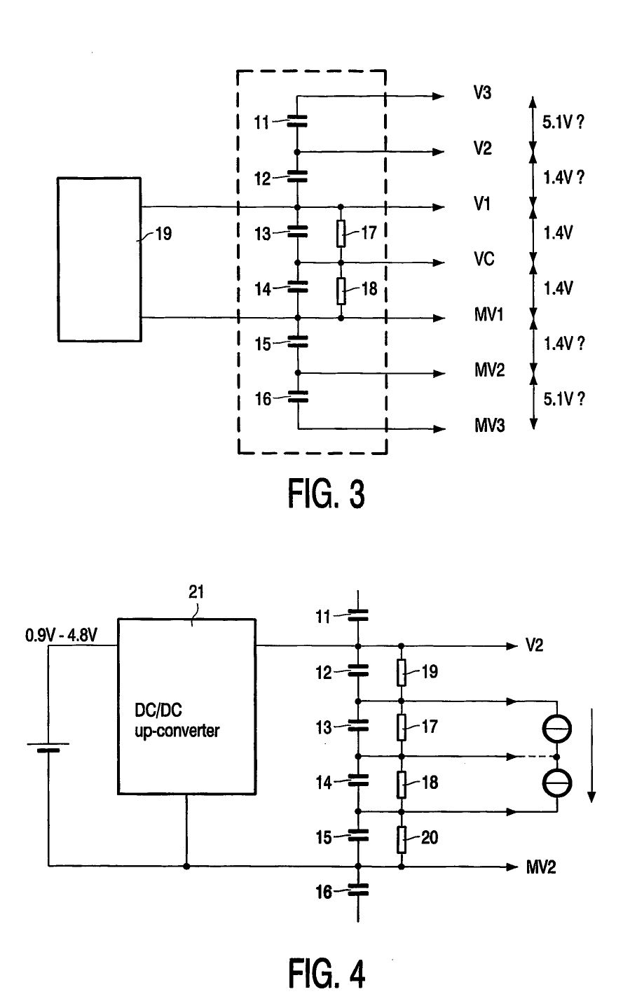

FIG. 3 shows part of an LCD system with a possible generation of the midpoint voltage VC;

FIG. 4 shows a non-applicable extension of the system in FIG. 3;

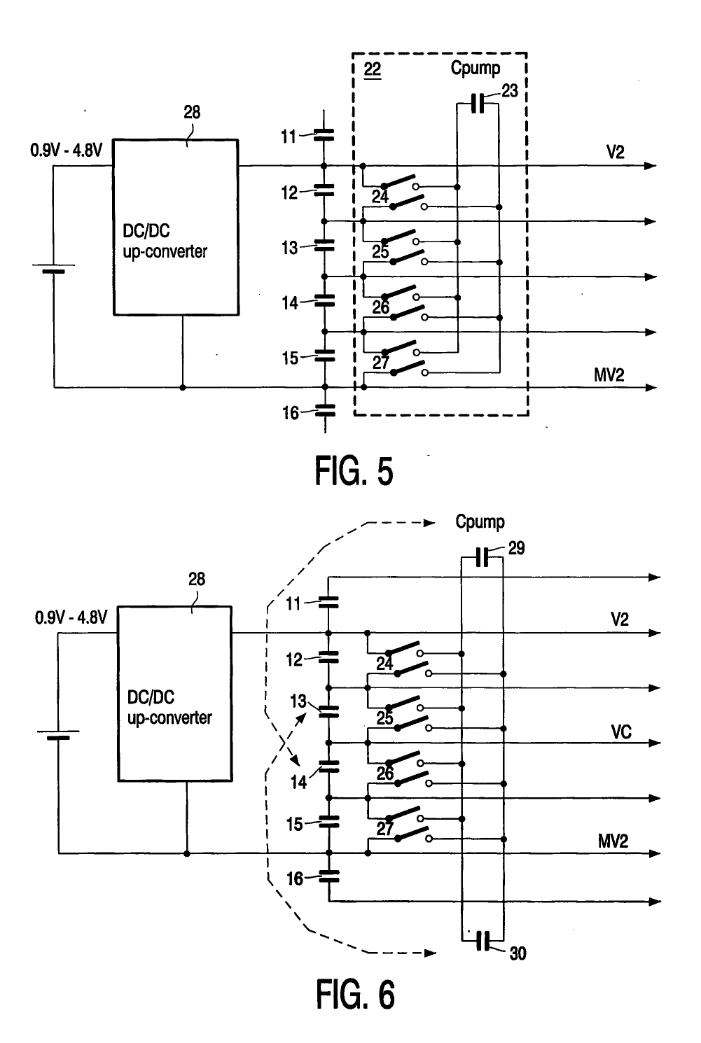

FIG. 5 shows a first embodiment of an LCD supply voltage generator with a DC/DC up-converter, in which generator charge pump technology is applied for voltage generation and reduction of energy consumption according to the invention;

FIG. 6 shows a second embodiment of such a voltage generator with an alternative implementation of the charge pump unit;

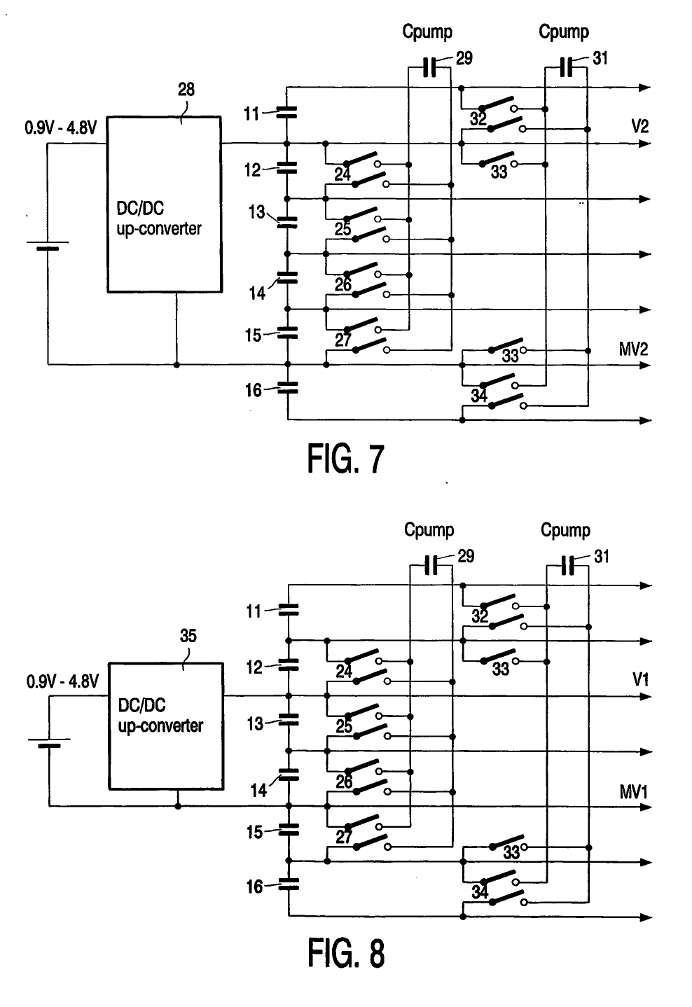

FIG. 7 shows a third embodiment of such a voltage generator with a second charge pump unit for providing additional drive voltages for the LCD system; and

FIG. 8 shows a fourth embodiment of an LCD supply voltage generator with a DC/DC down-converter and an implementation of the charge pump unit as illustrated in FIG. 7.

FIG. 1 is a basic diagram of an LCD system with means for generating a number of symmetrical LCD voltages in the form of an ICD supply voltage generator 1 fed by a battery 2 and LCD driver circuit 3 to supply the terminals of an LCD panel 4 with the LCD drive voltages. The LCD driver circuit 3 comprises matrix switching and control means in a known manner. A matrix of 68 rows and 98, or for a color panel 3×98, columns is a practical configuration for a cellular phone. The LCD system further comprises a processor with a control algorithm to control the above hardware; this processor is not indicated in the Figures.

As an example, the matrix switching and control means could require the following LCD drive voltages: V3=15.8 V; V2=10.7 V; V1=9.3 V; VC=7.9 V; MV1=6.5 V; MV2=5.1 V and MV3=0 V. These values are indicated in FIG. 1. 4 stacked voltages of 1.4 V centered around VC (Vcommon) that are in turn extended at both sides with 5.1 V can be recognized from these values. For the LCD, the voltage level to ground is of no relevance; any level other than MV3 could be chosen as zero reference. The required voltage range exceeds that of the voltage provided by the battery 2, which supplies, for example, fully charged, a voltage of max. 4.8 V, so that some form of voltage up-conversion must be applied in the LCD supply voltage generator 1. The LCD drive voltages for the LCD driver circuit 3 need to be well-controlled and independent of the battery charge status.

Although the load formed by the LCD panel 4 is capacitive, this does not mean that the LCD drive voltages delivered to the driver circuit 3 do not have to provide a DC current. However, the DC component of the drive voltages delivered by the LCD driver circuit 3 must be zero. This is achieved by alternately driving the LCD driver circuit 3 with the same voltage but with opposite polarity. A practical way of doing so implies the existence of complementary drive voltages. The above drive voltages, which have values symmetrical with respect to the value of VC, can realize this. For example, the voltage differences V1−VC and VC−MV1 provide an equal current flow into and from the terminal VC, as will be shown in the further description.

The LCD supply voltage generator 1 has to deliver the drive currents. Although the load is capacitive, the net currents to be delivered by the supply voltage generator are not zero. The most significant currents are those from V1 via a respective load to VC and from VC via a suchlike load to MV1. In a practical LCD system, large unipolar current pulses of the order of magnitude of 100 mA will flow from V1 to VC and subsequently from VC to MV1. These current pulses may sum up to an average current flowing from one supply terminal into an other of, for example, 250 μA.

FIG. 2 shows an example of an LCD system wherein the LCD drive circuit 3 and the LCD panel 4 are replaced by an equivalent diagram 5, illustrating the average load currents by means of arrows. Short peak capacitive load currents are subsequently generated in an adequately chosen sequence in the LCD drive circuit 3. This means that the load currents are flowing in different time slots depending on the driver scheme in the LCD drive circuit 3. This sequence is realized by means of the control algorithm of the processor in the LCD system.

As an example, the average load currents may be: V3→V1=12.5 μA; V3→MV1=12.5 μA; V2→VC=0.50 μA; and V1→VC=250 μA. The symmetrical other ones are the same.

In the example of FIG. 2, the output drivers 6-10 in the LCD supply voltage generator 1 provide the LCD drive voltages V2, V1, VC, MV1, and MV2. For practical reasons these output drivers are fed with the highest and lowest voltages V3 and MV3. However, more adequate supply voltages may be chosen.

As was stated above, the average current is composed of a large number of short peaks flowing in different time slots that depend on the driver scheme. The existence of the large current pulses is caused by the application of voltage steps across the capacitive loads. The application of decoupling or buffer capacitors 11-16 at the output of the driver 6-10 relaxes the required performance of these drivers, because the large current peaks are provided by the capacitors in this case, and it is only the drivers 6-10 that must supply the average current. In this case, the drivers may have a low current drive capability and a higher output impedance, which means smaller circuits in an IC.

In the system of FIG. 2, the average load current is supplied via the output drivers 6-10, which drivers provide the LCD drive voltages V2, V1, VC, MV1, and MV2. Power is dissipated in each of the drivers 6-10 in dependence on its supply voltage, in this case the values V3 and MV3, and the load currents. Even with a more complex implementation, where the smallest possible supply voltage for each driver is used, the power dissipation remains a point of concern.

In LCD systems, the ac operation conditions imply load currents that are substantially equal for sets of two load current supply sources. So, the load currents from V1 to VC and subsequently from VC to MV1 effectively yield a net current of zero in the VC terminal. When considering the load current of VC, the use of decoupling capacitors implies that the DC impedance of the VC drive voltage may be rather high since the average current is zero. This makes it possible to apply two resistors 17 and 18 for the generation of VC instead of output drivers. Such a generation of the midpoint voltage VC is shown in FIG. 3. A voltage converter 19 generates the voltages VI and MV1. Although the application of simple resistors instead of drivers is a cheap solution and diminishes the dissipation of energy by the omission of drivers, this solution is not very efficient because the generation of the other LCD drive voltages meets with further difficulties, as will be explained with reference to FIG. 4.

As is shown in FIG. 2, the voltages V2, V1, VC, MV1, and MV2 can be generated with DC drivers 6-9 aided by decoupling capacitors 11-16 for providing the instantaneous very high load peaks. When no DC current needs to be delivered, high-ohmic resistors may already provide the proper DC voltage. This is the case for VC as illustrated in FIG. 3. With four equal voltages V2-V1, V1-VC, VC-MV1, and MV1-MV2 as required, this measurement can only be made if the DC load current in the terminals for V1, VC, and MV1 is zero. This, however, is not the case. When looking at FIG. 2, the load currents from V1 to VC and subsequently from VC to MV1 are not supplied other than via the respective drivers. As illustrated in the above example for the load currents, the current delivered from V2 to VC and subsequently from VC to MV2 does not cause a substantial net current flow into VC. In FIG. 4, an LCD voltage generator is depicted in which this no-current load condition of four equal LCD voltage differences can be answered with high-ohmic resistors 17-20. However, the actual current load would change the DC potential of the several drive voltages. The application of low-ohmic resistors is not acceptable because of energy losses and the application of resistors with different values for providing the appropriate voltages is only possible with well-defined and constant currents. This is not possible since the load current of an LCD panel is determined by the picture content. Departing from four equal voltages of 1.4 V at no-current load, the two middle capacitors 13 and 14 would be discharged and the two neighboring capacitors 12 and 15 would be charged due to the load current, so that the voltages V1-VC and VC-MV1 would be lower than 1.4 V and the voltages V2-V1 and MV1-MV2 would be higher than 1.4 V. It is to be noted that the voltage up-converter 21 generates the voltages V2 and MV2.

As can be recognized from FIG. 4, with equal capacitor values, the LCD supply voltage generator delivers half the load current via the capacitors 12 and 15. The inner capacitors 13 and 14 are discharged and the neighboring capacitors 12 and 15 are charged. This means that a better approach would be the application of driver circuits for the definition of the several de voltages. However, that is still not an energy-efficient solution.

According to the invention, the application of charge-pump technique can provide a redistribution of charge, i.e. charge can be transferred from the two charged capacitors 12 and 15 to the two discharged capacitors 13 and 14. An LCD system requiring a charge pump unit 22 in the form of a combination of a single charge pump capacitor 23 and switches 24-27 is depicted in FIG. 5. The pump capacitor 23 is subsequently connected via said switches 2427 in parallel to the stacked capacitors 12-15 and transfers charge from one capacitor to the other. The moment a drive voltage should be disturbed because of a certain load current, the pump capacitor will restore the respective drive voltage. The resistance value may be high in this system. As was found in practice, up to now only the pump technique has provided the correct voltage distribution under load conditions such that the resistors can even be omitted. Energy is transferred from one capacitor to the other, and the current to be supplied from the DC/DC converter can theoretically be half the original one.

It is to be noted that, as is the case in the embodiment of FIG. 4, the voltage up-converter 28 generates the voltages V2 and MV2. The voltages V1, VC, and MV1 are obtained by a pump technique instead of resistors, as in the embodiment of FIG. 4.

In practice, it may be advantageous to apply more pump capacitors for reasons of ripple, available component values, preferred switching frequency, etc. A configuration using two pump capacitors 29 and 30 is depicted in FIG. 6. This configuration shows a first group with pump capacitor 29 and switches 24 and 25 and a second group with pump capacitor 30 and switches 26 and 27.

In FIG. 6, no adequate measures are taken to define the midpoint dc voltage (i.e. VC). Again, this can be achieved by the application of a driver circuit or a pair of resistors.

In this specific situation of the load, only some possible asymmetry caused by leakage, circuit load, etc., must be accommodated. For larger asymmetry it is better to create an overlap of the two switch-capacitor groups. This somewhat resembles twice the situation as depicted in FIG. 5 or, for example, a situation in-between where only the two middle capacitors 13 and 14 are connected via the additional switches to the pump capacitors 29 and 30 of the two groups. This implies an additional charge transfer from one pump capacitor to the other as indicated by the dashed arrows in FIG. 6.

Up to now, no attention has been paid to the outer voltages of 5.1 V. Again, these voltages can be derived by charge pump technology from an available voltage in the system. Such an adequate voltage is available between nodes V2 and MV2. Therefore, the embodiment in FIG. 5 is extended by the addition of an extra pump capacitor 31 and switches 32-34 as depicted in FIG. 7.

FIG. 8 shows substantially the same embodiment as FIG. 7. However, instead of an up-converter to derive the drive voltages V2 and MV2, a down-converter 35 is applied to derive the drive voltages V1 and MV1. This embodiment may have advantages as down-conversion can be realized more cheaply than up-conversion. The drive voltage VC is defined by means of the pump capacitor 29 and the switches 25 and 26, while the drive voltages V3, V2, MV2, and MV3 are defined by both pump capacitors 29 and 31 and switches 24, 27 and 32-34.

It will be clear that the sequence of load currents and the control thereof as well as the control of the switches of the charge pump unit can be realized by means of a processor which forms part of the LCD system. The sequence of the load currents can be coupled to the control of the switches of the charge pump unit. Furthermore, the control of the LCD system may be synchronous or asynchronous, at the same frequency or at different frequencies. This may have advantages with respect to picture artefacts.

The invention is not restricted to the described embodiments; modifications within the scope of the following claims are possible. Particularly, the charge pump unit may be realized in different ways through the arrangement of more pump capacitors and other configurations of switches. More charge pump units may be provided. Furthermore, for example, the configuration of FIG. 6 may be combined with that of FIG. 7, resulting in an LCD system with two charge pump units with a total of three pump capacitors, each operable with a set of switches: a first pump capacitor 29 and switches 24 and 25 for defining LCD drive voltages V2, V1, and VC, a second pump capacitor 30 with switches 26 and 27 for defining LCD drive voltages VC, MV1, and MV2, and a third pump capacitor 31 with switches 32, 33, and 34 for defining the LCD drive voltages V3 and MV3. In general, the LCD system in this case is characterized in that the means for generating a number of LCD drive voltages comprises a DC/DC converter to supply an output voltage for the configuration of buffer capacitors, and that a first charge pump unit is provided comprising at least one first pump capacitor and respective switches to define a first group of equal LCD drive voltage differences and at least one second pump capacitor and respective switches to define, in combination with the at least one first pump capacitor and respective switches, a second group of equal LCD drive voltages, the latter voltage differences being equal to the LCD drive voltage differences of the first group, and a second charge pump unit comprising at least one third pump capacitor and respective switches to define an additional group of equal LCD drive voltage differences.

It is a constraint relating to liquid crystals that drive voltages must be applied that have an average value of zero. For this, a number of drive voltages that have substantially symmetrical values around VC need to be made available; the examples in the Figures and in the description offer an LCD system with 4 substantially equal LCD drive voltage differences around midpoint VC. It is to be understood that this system may be extended to systems that provide more than 4 of such voltage differences, particularly for color LCDs.

Although the examples in the Figures and description show a series connection of buffer capacitors for keeping the LCD drive voltages substantially constant when the related terminals are subject to some current, alternative buffer capacitor configurations as indicated in the introductory part of the description are equally possible.

It may further be noted that the type of DC/DC converter is irrelevant. The converter may be inductive (up, down and up/down) or capacitive; in the latter case charge pump techniques will be applied. The choice of converter will be determined by costs, actual input voltage range, and required efficiency.

1. Liquid crystal display (LCD) system, comprising means for generating a number of LCD drive voltages with values symmetrical with respect to a predetermined voltage value, said means having a configuration of buffer capacitors to provide each of the LCD drive voltages with a buffer capacitance, the LCD system further comprising an LCD driver circuit with matrix switching and control means to supply the terminals of an LCD panel with voltages corresponding to said LCD drive voltages, resulting in a proper light level of the pixels of the LCD panel, characterized in that at least one charge pump unit with at least one pump capacitor and switching elements is connected to the buffer capacitors.

2. LCD system according to claim 1, characterized in that the means for generating a number of LCD drive voltages comprises a DC/DC converter to supply an output voltage for the configuration of buffer capacitors, and that a charge pump unit is provided comprising at least one first pump capacitor and respective switches to define a first group of LCD drive voltage differences and at least one second pump capacitor and respective switches to define, in combination with the at least one first pump capacitor and respective switches, a second group of LCD drive voltage differences, the latter voltage differences being substantially equal to the LCD drive voltage differences of the first group (FIG. 6).

3. LCD system according to claim 1, characterized in that the means for generating a number of LCD drive voltages comprises a DC/DC converter to supply an output voltage for the configuration of buffer capacitors, and that a first charge pump unit is provided comprising at least one pump capacitor and respective switches to define a first group of LCD drive voltage differences, and a second charge pump unit comprising at least one pump capacitor and respective switches to define a second group of LCD drive voltage differences (FIGS. 7 and 8).

4. LCD system according to claim 1, characterized in that the means for generating a number of LCD drive voltages comprises a DC/DC converter to supply an output voltage for the configuration of buffer capacitors, and that a first charge pump unit is provided comprising at least one first pump capacitor and respective switches to define a first group of substantially equal LCD drive voltage differences and at least one second pump capacitor and respective switches to define, in combination with the at least one first pump capacitor and respective switches, the same group of substantially equal LCD drive voltages (FIG. 6).

5. LCD system according to claim 1, characterized in that the means for generating a number of LCD drive voltages comprises a DC/DC converter to supply an output voltage for the configuration of buffer capacitors, and that a first charge pump unit is provided comprising at least one first pump capacitor and respective switches to define a first group of LCD voltage differences and at least one second pump capacitor and respective switches to define, in combination with the at least one first pump capacitor and respective switches, a second group of LCD drive voltages, the latter voltage differences being substantially equal to the drive voltage differences of the first group, and a second charge pump unit comprising at least one third pump capacitor and respective switches to define an additional group of substantially equal LCD drive voltage differences (combination of FIGS. 6 and 7).

6. LCD system according to claim 2, characterized in that the means for generating a number of LCD drive voltages comprises a DC/DC up-converter fed with a battery voltage so as to generate the LCD drive voltages (FIGS. 5-7).

7. LCD system according to claim 2, characterized in that the means for generating a number of LCD drive voltages comprises a DC/DC down-converter fed with a battery voltage so as to generate the LCD drive voltages (FIG. 8).
